(19) United States
(12) Patent Application Publication
(10) Pub. No.: US 2007/0164947 A1
(43) Pub. Date: Jul. 19, 2007

(54) Method for Improving Display Uniformity

(76) Inventors: Yu-Wen Lin, Taichung County (TW); Kun-Lang Wu, Taichung County (TW); Chung-Lung Li, Taipei City (TW); Cho-Shien Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/422,886

(22) Filed: Jun. 8, 2006

(30) Foreign Application Priority Data
Jan. 16, 2006 (TW) 095101613

(51) Int. Cl. G09G 3/36

(52) U.S. Cl. 345/87

(57) ABSTRACT

A method for driving a panel includes measuring common electrode voltage characteristics of the panel in the X and Y direction of the panel, and modifying driving voltages of the pixel units based on the corresponding measured common electrode voltage characteristics. The pixel units on different locations of the panel can thus be provided with a best symmetric center during the positive and negative driving periods.

### BACKGROUND OF THE INVENTION

1. Field of the Invention

The present invention relates to a method for driving a panel, and more particularly, to a method for improving display uniformity of a panel.

2. Description of the Prior Art

A liquid crystal display (LCD) panel usually includes two glass substrates. A liquid crystal layer composed of liquid crystal molecules is located between the two glass substrates, where one of the glass substrates is a pixel electrode, and the other glass substrate is a common electrode. When applied voltage between the two glass substrates changes, an arrangement direction of the liquid crystal molecules will also be changed accordingly. Hence, the light transmittance of the liquid crystal molecules can be changed based on the applied voltage so as to provide images of different gray scales.

As for the general effect, if the voltage difference between the two glass substrate is biased towards a certain polarity for a long period of time, the liquid crystal molecules will fail to correctly rotate or arrangement direction in response to the designed applied voltage. Under such circumstance, the display images may not have the expected gray scale values. What is worse is that as the applied voltage difference between the two glass substrates is biased towards a certain polarity so long that the liquid crystal molecules are permanently damaged, the liquid crystal molecules will no longer react to a change in the electric field. Therefore, in order to prevent permanent damage to the liquid crystal molecules, the applied voltage utilized for driving the liquid crystal molecules is usually altered periodically between the positive and negative polarities. In general, the voltage applied on the two glass substrates is categorized into two types of polarities: a positive polarity driving in which the voltage of the pixel electrode layer is higher than a common voltage V_{com} of the common electrode, and a negative polarity driving in which the voltage of the pixel electrode layer is lower than the common voltage V_{com} of the common electrode. The objective here is to allow the liquid crystal molecules to display uniform illumination gray scale regardless of the positive polarity driving or negative polarity driving. In other words, as long as the absolute voltage difference between the two glass substrates is constant, the image displayed by the liquid crystal modules has the same gray scale, regardless of whether the voltage of the pixel electrode layer is higher, or the voltage of the common electrode is higher.

Referring to FIG. 1. FIG. 1 illustrates a diagram of a thin film transistor (TFT) liquid crystal display (LCD) panel 10. The LCD panel 10 includes a source driver 11, a gate driver 12, a plurality of parallel data lines DL₁˜DLₘ, a plurality of parallel gate lines GL₁˜GLₙ, and a plurality of pixel units P₁₁˜Pₘₙ. The data lines DL₁˜DLₘ are electrically coupled to the source driver 11, and are installed on the LCD panel 10 in an Y direction in a parallel manner. The gate lines GL₁˜GLₙ are electrically coupled to the gate driver 12, and are installed on the LCD panel 10 in a X direction in a parallel manner. Thus, the data lines DL₁˜DLₘ and the gate lines GL₁˜GLₙ are perpendicular to each other. Each of the pixel units P₁˜Pₘₙ includes a TFT, a liquid crystal capacitor C_{LC}, and a storage capacitor C_{CS}. Each liquid crystal capacitor C_{LC} is electrically coupled between a source of the TFT and a common voltage V_{COM}, each storage capacitor C_{CS} is electrically coupled between a source of the TFT and a voltage V_{CS}. The TFTs, each having a gate electrically coupled to a corresponding gate line, can be turned on or turned off based on signals sent from the gate driver 12. A drain of each TFT is electrically coupled to a corresponding data line for receiving data transmitted from the source driver 11. When a TFT is turned on, the source driver 11 can transmit data to the liquid crystal capacitor C_{LC} and storage capacitor C_{CS} of a corresponding pixel unit through a corresponding data line, hence the pixel unit can display images of different gray scales according to the data received.

Referring to FIG. 2. FIG. 2 illustrates a diagram of the voltage outputted to a pixel unit and a corresponding common voltage V_{COM} under an ideal situation. In FIG. 2, V_{N} represents electric potential of a pixel unit in an N^{th} period, V_{N+1} (represented as a dotted line in FIG. 2) represents electric potential of the pixel unit in an (N+1)^{th} period, V_{com} represents electric potential of common voltage of the pixel unit, and D₁˜D₈ respectively represent data displayed by the pixel unit at time points T₁˜T₈. If the gray scale values of data are FF and 80, the corresponding pixel voltage is V_{FF} and V₈₀ in the positive driving period, and the corresponding pixel voltage is V_{FF}′ and V₈₀′ in the negative driving period. At time point T₁, if the data gray scale value to be displayed by the pixel unit is FF, thus the pixel electric potential V_{N} in the N^{th} period is V_{FF}, and the pixel electric potential V_{N+1} in the (N+1)^{th} period is V_{FF}′. Regardless of positive or negative driving, the absolute values of voltage differences between the pixel electric potentials and the common voltage V_{COM}|V_{FF}−V_{COM}| and |V_{COM}−V_{FF}′| are equal. At time point T₂, if the data gray scale value to be displayed by the pixel unit is 80, thus the pixel electric potential V_{N} in the N^{th} period is V₈₀, and the pixel electric potential V_{N+1} in the (N+1)^{th} period is V₈₀′. Regardless of positive or negative driving, the absolute values of voltage differences between the pixel electric potentials and the common voltage V_{COM}|V₈₈−V_{COM}| and |V_{COM}−V₈₈′| are equal. At time point T₃, if the data gray scale value to be displayed by the pixel unit is 0, the pixel electric potentials V_{N} and V_{N+1} in the N^{th} and (N+1)^{th} periods are both equal to the common voltage V_{COM}. Thus the absolute values of voltage differences between the pixel electric potentials and the common voltage V_{COM} are 0. Similarly, at time T₄˜T₈, the electric potential of the pixel electric potentials V_{N} and V_{N+1} will have different electric potential according to D₄˜D₈ and the positive and negative driving. Thus, the liquid crystal molecules are driven by the positive and negative polarities in order to display the gray scale value of a data with a constant voltage difference. However, the rotation direction of the liquid crystal molecules will not always remain in the same status in order to prevent permanent damage of the liquid crystal molecules.

A charge voltage applied on the pixel unit P₁₁˜Pₘₙ is provided by the source driver 11. A best common voltage V_{COM} of the LCD panel 10 can be obtained if the charge electric potentials applied to each pixel unit has a best symmetric center when alternating between positive and negative polarity driving. When a conventional method is driving the LCD panel 10, the common voltage V_{COM} value is maintained at a fixed voltage value, and the charge voltage applied on the pixel unit changes accordingly to the alternating polarities. As the paths of the data lines DL₁˜DLₘ, the source lines GL₁˜GLₘ, and the common voltage V_{COM} in transmitting signals on the LCD panel 10 being different impedance and capacitance, thus the pixel units on different positions of the LCD panel 10 can have different best common voltages V_{COM}.

Referring to FIG. 3. FIG. 3 illustrates a diagram of a best common voltage V_{COMX} in an X direction of the LCD panel 10. In FIG. 3, the Y-axis represents a value of a best common voltage of a pixel unit electrically coupled to a gate line, and the X-axis represents an arrangement position of a pixel unit electrically coupled to the gate line in the X direction of the LCD panel 10. As illustrated in FIG. 3, in comparison to the pixel units on two ends of the panel, the pixel units in the middle of the panel have best common voltages V_{COMX} of higher voltage levels.

Referring to FIG. 4. FIG. 4 illustrates a diagram of a common voltage V_{COMY} in a Y direction of the LCD panel 10. In FIG. 4, the Y-axis represents a value of a best common voltage of a pixel unit electrically coupled to a data line, and the X-axis represents an arrangement position of the pixel unit electrically coupled to the data line in the Y direction of the LCD panel 10. As illustrated in FIG. 4, in comparison to the pixel units on two ends of the panel, the pixel units in the middle of the panel have best common voltages V_{COMY} of higher voltage levels.

Different LCD panels have different characteristics, and the relationship between the best common voltage and the pixel unit position also varies accordingly. In the conventional method where the common voltage V_{COM} for driving the LCD panel 10 is fixed at a constant value, if the value of the common voltage V_{COM} is determined according to the best common voltage characteristics of the pixel units in the middle of the panel, it cannot provide the pixel units at the two ends of the panel with a best symmetric center when displaying images of an identical gray scale. Similarly, if the value of the common voltage V_{COM} of the common electrode is determined according to the best common voltage characteristics of the pixel units at the two ends of the panel, it cannot provide the pixel units in the middle of the panel with a best symmetric center when displaying images of an identical gray scale. Therefore, the conventional method is unable to provide a best symmetric center for different pixel units, hence causing an image flicker or mura to appear on the LCD panel which can easily affect the display quality of the LCD panel.

### SUMMARY OF THE INVENTION

The present invention discloses a method for improving display uniformity of a panel, the panel comprising M parallel gate lines and N parallel data lines intersecting the gate lines. The method comprises modifying a level of a driving voltage applied to an m^{th} gate line according to a common electrode voltage of the panel measured at a position on the m^{th} gate line when each gate line is display images of the same gray scale; and modifying a level of a driving voltage applied to an nth data line according to a common electrode voltage of the panel measured at a position on the n^{th} data line when each data line displays images of the same gray scale; where m is an integer between 1 and M, and n is an integer between 1 and N.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a conventional thin film transistor (TFT) liquid crystal display (LCD) panel.

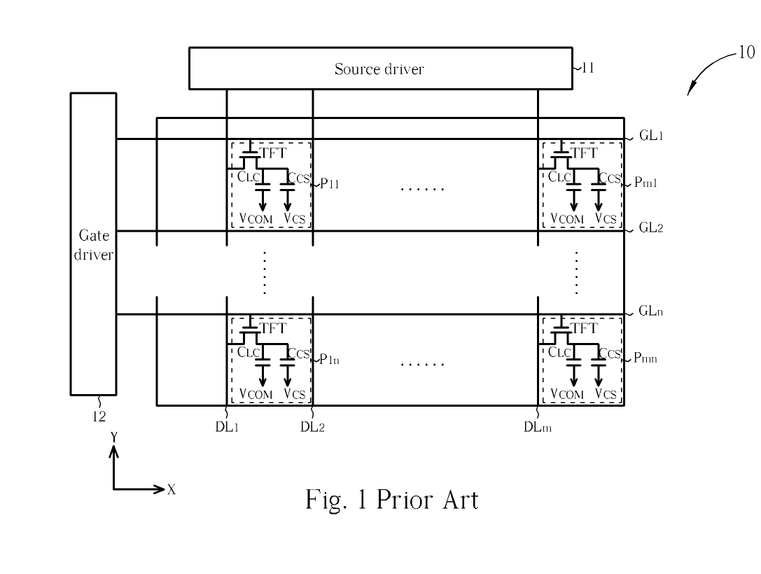

FIG. 2 illustrates a diagram of outputting to voltage and common voltage V_{COM} of a pixel unit under an ideal situation according to the prior art.

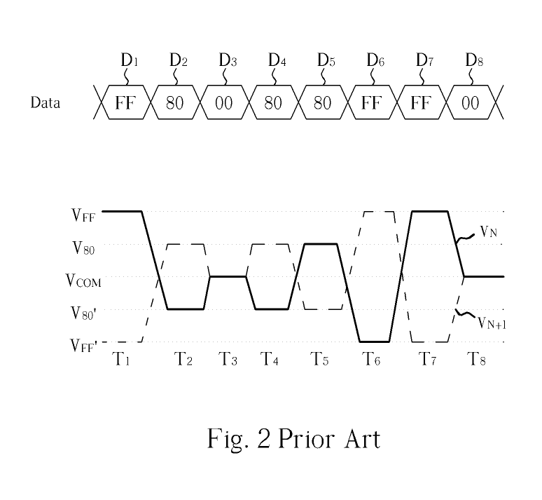

FIG. 3 illustrates a diagram of a best common voltage V_{COMX} in an X direction of an LCD panel according to the prior art.

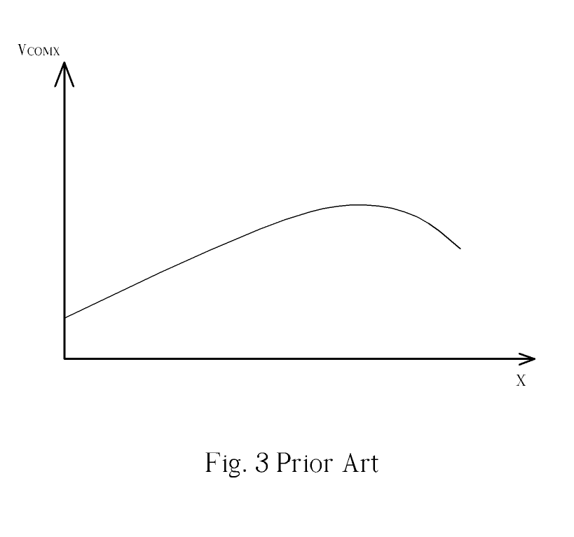

FIG. 4 illustrates a diagram of a common voltage V_{COMY} in a Y direction of an LCD panel according to the prior art.

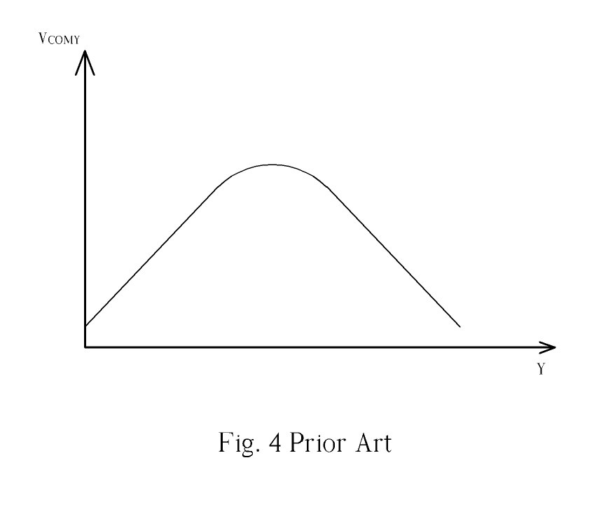

FIG. 5 illustrates a diagram of the electric potential in the X direction when the LCD panel is being driven according to the present invention.

FIG. 6 illustrates a diagram of the electric potential in the Y direction when an LCD panel is being driven according to the present invention.

FIG. 7 illustrates a flowchart of driving an LCD panel according to the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

The present invention provides a driving method capable of improving display uniformity of a panel. Based on the measured best common voltage characteristics of the panel in an X and a Y direction, driving signals for compensating the variations between different best common voltage characteristics and thus providing similar common voltage to the pixel units. Therefore, the pixel units on different locations of the panel can be provided with a best symmetric center during the positive and negative driving periods.

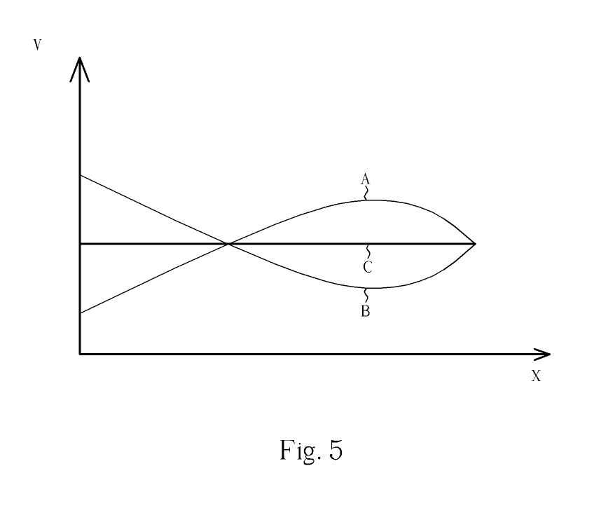

Referring to FIG. 5. FIG. 5 illustrates a diagram of the electric potential in the X direction when the LCD panel is being driven according to the present invention. The resolution of a 19-inch super extended graphics array (SXGA) LCD panel is used as an example. The LCD panel includes 1280*3 data lines in total. In FIG. 5, the X-axis represents an arrangement position of the data lines in the X direction of the LCD panel, and the Y-axis represents common electrode voltage value. Curve A represents a common voltage when each data line displays images of the same gray scale as a best common voltage V_{COMX}. The best common voltage V_{COMX} is a measurable panel characteristic, and curve A of different LCD panels can also be different. Curve B represents an X direction driving voltage value after each data line is being modified, and curve C represents actual measurement of common voltage on each data line. This aspect of the present invention differs with the conventional method of fixing the common voltage to drive the LCD panel in that the present invention applies the X direction driving voltage (i.e., curve B) of different voltage levels to the LCD panel. The voltage level of curve B is determined according to curve A of a different LCD panel to provide different charge potentials according to the best common voltage characteristics of each data line to modify the common voltage difference of the data lines at different locations on the panel such that the actual measurement of the common voltage of each data line is approximately identical, as illustrated in curve C. Therefore, the pixel units on different locations in the X direction of the panel can provide a best symmetric center during the positive and negative driving periods. Hence situations such as image flicker or mura will not occur which can increase the display quality of the LCD panel.

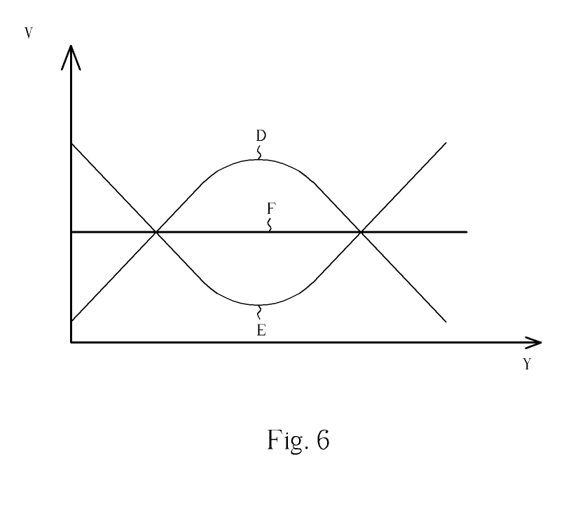

Referring to FIG. 6. FIG. 6 illustrates a diagram of the electric potential in the Y direction when the LCD panel is being driven according to the present invention. A 19-inch SXGA LCD panel is also used as an example, the LCD panel includes 1024 gate lines in total. In FIG. 6, the X-axis represents an arrangement position of the gate lines in the Y direction of the LCD panel, the Y-axis represents common electrode voltage value. Curve D represents a common voltage when each gate line displays image of the same gray scale as a best common voltage V_{COMY}. The best common voltage V_{COMY} is a measurable panel characteristic, and curve D of a different LCD panel can also be different. Curve E represents the Y direction driving voltage value after the signal modification, and curve F represents the actual measurement of common voltage after signal modification. This aspect of the present invention differs with the conventional method of fixing the common voltage to drive the LCD panel in that the present invention applies the Y direction driving voltage (i.e., curve E) of different voltage levels to the LCD panel. The voltage level of curve E is determined according to curve D of different LCD panels to provide different charge potentials according to best common voltage characteristics in the Y direction of the panel to modify the common voltage difference of the gate lines at different locations on the panel such that actual measurement of the common voltage of each gate line is approximately identical, as illustrated in curve F. Therefore, the pixel units on different locations in the Y direction of the panel can provide a best symmetric center during the positive and negative driving periods. Hence situations such as image flicker or mura will not occur which can increase the display quality of the LCD panel.

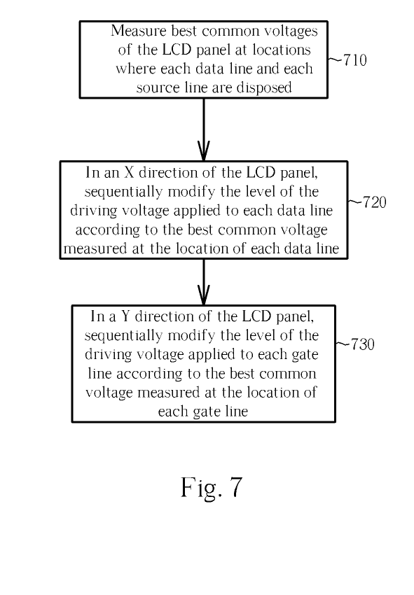

Referring to FIG. 7. FIG. 7 illustrates a flowchart of driving an LCD panel according to the present invention. The flowchart of FIG. 7 includes the following steps:

Step 710: measure best common voltages of the LCD panel at locations where each data line and each source line are disposed;

Step 720: in an X direction of the LCD panel, sequentially modify the level of the driving voltage applied to each data line according to the best common voltage measured at the location of each data line; and

Step 730: in a Y direction of the LCD panel, sequentially modify the level of the driving voltage applied to each gate line according to the best common voltage measured at the location of each gate line.

In the present invention, the modification in the X direction of the LCD panel can be sequentially executed from the first data line to the last data line. The level of the driving voltage applied to each data line can be adjusted according to the best common electrode voltage measured in the X direction; similarly the modification in the Y direction of the LCD panel can be sequentially executed from the first gate line to the last gate line. The level of the driving voltage applied to each gate line can be adjusted according to the best common electrode voltage measured in the Y direction. Signal adjustment reduces the best common electrode voltage difference of the X direction and Y direction to a minimum, or even close to uniformity so that the pixel units on different locations of the LCD panel can provide a best symmetric center between the charge potential during the positive and negative driving periods. Hence situations such as image flicker or mura will not occur which can increase the display quality of the LCD panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for improving display uniformity of a panel, the panel comprising M parallel gate lines and N parallel data lines intersecting the gate lines, the method comprising:
(a) modifying a level of a driving voltage applied to the m^{th} gate line according to a common electrode voltage of the panel measured at a position on the m^{th} gate line when each gate line displays images of the same gray scale; and
(b) modifying a level of a driving voltage applied to an n^{th} data line according to a common electrode voltage of the panel measured at a position on the n^{th} data line when each data line displays images of the same gray scale;
where m is an integer between 1 and M, and n is an integer between 1 and N.

2. The method of claim 1, further comprising:
measuring the common electrode voltage of the panel at the position on the m^{th} gate line.

3. The method of claim 1, further comprising:
measuring the common electrode voltage of the panel at the position on the n^{th} data line.

4. The method of claim 1, further comprising:
modifying a level of a driving voltage applied to an (m+1)^{th} gate line according to a common electrode voltage of the panel measured at the position on the (m+1)^{th} gate line.

5. The method of claim 4, further comprising:
measuring the common electrode voltage of the panel measured at the position on the (m+1)^{th} gate line.

6. The method of claim 1, further comprising:
modifying a level of a driving voltage applied to an (m−1)^{th} gate line according to a common electrode voltage of the panel measured at the position on the (m−1)^{th} gate line.

7. The method of claim 6, further comprising:
measuring the common electrode voltage of the panel measured at the position on the (m−1)^{th} gate line.

8. The method of claim 1, further comprising:
modifying a level of a driving voltage applied to an (n+1)^{th} data line according to a common electrode voltage of the panel measured at the position on the (n+1)^{th} data line.

9. The method of claim, 8 further comprising:
measuring the common electrode voltage of the panel at the position on the (n+1)^{th} data line.

10. The method of claim 1, further comprising:
modifying a level of a driving voltage applied to an (n−1)^{th} data line according to a common electrode voltage of the panel measured at the position on the (n−1)^{th} data line.

11. The method of claim 10, further comprising:
measuring the common electrode voltage of the panel at the position on the (n−1)^{th} data line.
